(19) United States
(12) Patent Application Publication
(10) Pub. No.: US 2010/0230994 A1
(43) Pub. Date: Sep. 16, 2010

(54) Device for manipulating a tarpaulin

(76) Inventor: Real Royer, Saint-Hyacinthe (CA)

Correspondence Address: Louis Tessier, P.O. Box 54029, Town of Mount-Royal, QC, H3P 3H4, CA

(21) Appl. No.: 12/382,313

(22) Filed: Mar. 13, 2009

(51) Int. Cl. B60P 7/02

(52) U.S. Cl. 296/100.16

(57) ABSTRACT

A device for manipulating a tarpaulin to selectively cover and uncover a top aperture of a container, the device being usable in combination with an actuator, the device comprising: a rod for rolling the tarpaulin therearound, the rod defining a rod longitudinal axis; a mounting bracket attachable to the container in a spaced apart relationship relatively to the top aperture; an articulated linking element defining a linking element first end and a substantially opposed linking element second end, the articulated linking element being pivotally attached to the mounting bracket substantially adjacent to the linking element first end, the articulated linking element being rotatably attached to the rod substantially adjacent to the linking element second end, the articulated linking element being movable between a first configuration and a second configuration, the articulated linking element being in the first configuration when the tarpaulin is in a retracted configuration, and the articulated linking element being in the second configuration when the tarpaulin is in an extended configuration; and a transmission operatively coupled to the actuator and to the rod for rotating the rod about the rod longitudinal axis when the actuator is actuated.

### FIELD OF THE INVENTION

The present invention relates generally to tarpaulins. More specifically, the present invention is concerned with a device for manipulating a tarpaulin.

### BACKGROUND OF THE INVENTION

Vehicle cargo containers for transporting bulk material such as sawdust, gravel chip, cutter shavings and the like typically include open top boxes such as semi-trailers or the like defining side walls, a front wall, a rear wall and a floor. These open top containers are typically mechanically coupled to various types of vehicles such as cargo ships, railway carts and truck cabins for transporting goods between various locations.

During transportation in these so-called open top containers, there exists a substantial risk that a portion of the load may be blown out of the open top container by various physical phenomena such as vibration, aerodynamically created vacuum, wind or the like. If some of the load is accidentally blown out of the container it may potentially not only cause unnecessary wastage of the transported goods but may also create a dangerous situation.

For example, when the open-top container is attached to a truck cabin, some of the load accidentally blown out of the container may contaminate the road or highway as it whirls around thus causing dangerous ground road conditions. It may also be blown directly towards the windshield of following vehicles creating a potentially disastrous situation.

Accordingly, in many areas, regulations have been implemented for the carriage of various loads, particularly on public highways requiring that open top containers be provided with some type of covering structure for covering the loading aperture during transport. With the increasing number of accidents, these official requirements have become more and more stringent, sometimes requiring adequate coverage for the load on even short journeys.

Consequently, there has been an industry wide move to provide permanently installed flexible covers often referred to as tarpaulins or tarps that can be quickly rolled and unrolled by the driver so as to respectively allow selective uncovering and covering of the load. When these permanently installed tarpaulins are used only occasionally they may be stored on the vehicle in a folded condition and unfolded over the body as and when required.

Various configurations of tarpaulins have been proposed. However, two configurations have proven to be particularly popular. One such configuration is the so called end-rolled tarpaulin which is gathered at one of the longitudinal ends of the container when not in use and moved along the body of the container between operative and stored positions.

The end-rolled tarpaulins are typically gathered at the front end of the vehicle and are usually provided along their length with a number of transverse supporting bars which extend between the two longer side walls of the container. The end-rolled tarpaulins are typically moved by means of a pair of cables trained over pulleys and carrying the tarpaulins with them as they move. With such an arrangement, the movement of the tarpaulin typically moves the bows automatically out of the way so that the latter do not obstruct the re-loading through the top opening. The movement of the bows out of the way also reduces the risks of having the latter damaged by a new load.

The other type of permanently installed tarpaulins preferred by some haulers is commonly referred to as a side-rolled tarpaulin. The side-load tarpaulins, typically, permanently extend the full length of the container body and are rolled and unrolled about a so-called rolling rod that also typically extends the full length of the container body.

Many devices exist for retracting an extending these tarpaulins. However, these devices are typically relatively complex. In addition, they often require that an intended user of the device climb onto the container onto which the tarpaulin retracting and extending device is positioned. This causes risks of injury to the intended user of these devices as the intended user may then fall from the container. In addition, these devices often require that the intended user perform movements in non-ergonomic positions, which may also lead to injuries.

Against this background, there exists a need in the industry to provide a novel device for manipulating a tarpaulin.

An object of the present invention is therefore to provide a device for manipulating a tarpaulin.

### SUMMARY OF THE INVENTION

In a first broad aspect, the invention provides a device for manipulating a tarpaulin to selectively cover and uncover a top aperture of a container, the tarpaulin being configurable between an extended configuration and a retracted configuration, wherein, in the extended configuration, the tarpaulin substantially covers the top aperture, and, in the retracted configuration, the tarpaulin is substantially retracted from the top aperture, the device being usable in combination with an actuator, the device comprising: a rod for rolling the tarpaulin therearound when configuring the tarpaulin from the extended configuration to the retracted configuration and for unrolling the tarpaulin therefrom when configuring the tarpaulin from the retracted configuration to the extended configuration, the rod defining a rod longitudinal axis; a mounting bracket attachable to the container in a spaced apart relationship relatively to the top aperture; an articulated linking element, the articulated linking element defining a linking element first end and a substantially opposed linking element second end, the articulated linking element being pivotally attached to the mounting bracket substantially adjacent to the linking element first end, and the articulated linking element being rotatably attached to the rod substantially adjacent to the linking element second end, the articulated linking element being movable between a first configuration and a second configuration, the articulated linking element being in the first configuration when the tarpaulin is in the retracted configuration, and the articulated linking element being in the second configuration when the tarpaulin is in the extended configuration; and a transmission operatively coupled to the actuator and to the rod for rotating the rod about the rod longitudinal axis when the actuator is actuated; whereby, upon the actuator being actuated, the rod is rotated about the rod longitudinal axis through the transmission and moved across the top aperture, which, in turn, moves the articulated linking element between the first and second configurations, movements between the first and second configurations of the articulated linking element allowing the rod to remain linked to the actuator while remaining substantially adjacent to said top aperture as the rod is moved thereacross between the extended and retracted configurations.

Advantageously, the proposed device is relatively simple to operate using a series of relatively simple, quick and ergonomic steps.

The proposed device is relatively easily manufactured using known techniques and materials. In addition, the proposed device is relatively economical to produce and, in some embodiments of the invention, is retrofittable to existing containers.

In some embodiments of the invention, the articulated linking element includes a pair of arms that are pivotally attached to each other. A pair of substantially longitudinally spaced apart sprockets is rotatably mounted to each arm and a chain is mounted to each pair of sprockets. One of the sprockets mounted to the first arm is rotatable jointly with one of the sprockets mounted to the second arm, thereby coupling the movements of the two chains. The other ones of the sprockets are coupled respectively to the actuator and to the rod. Therefore, rotating the first chain using the actuator rotates the second chain, which in turn rotates the rod about the rod longitudinal axis.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, in a perspective view, illustrates a device for manipulating a tarpaulin in accordance with an embodiment of the invention, the device being shown attached to a container and manipulating the tarpaulin;

FIG. 2, in a partial top plan view, illustrates the attachment of an actuator to the device shown in FIG. 1;

FIG. 3, in a partial top plan view, illustrates the attachment of two arms part of the device shown in FIG. 1;

FIG. 4, in a partial top plan view, illustrates the attachment of one of the arms part of the device shown in FIG. 1 to a rod around which the tarpaulin is rollable;

FIG. 5, in a perspective exploded view, illustrates an actuator shown in FIGS. 1 and 2.

### DETAILED DESCRIPTION

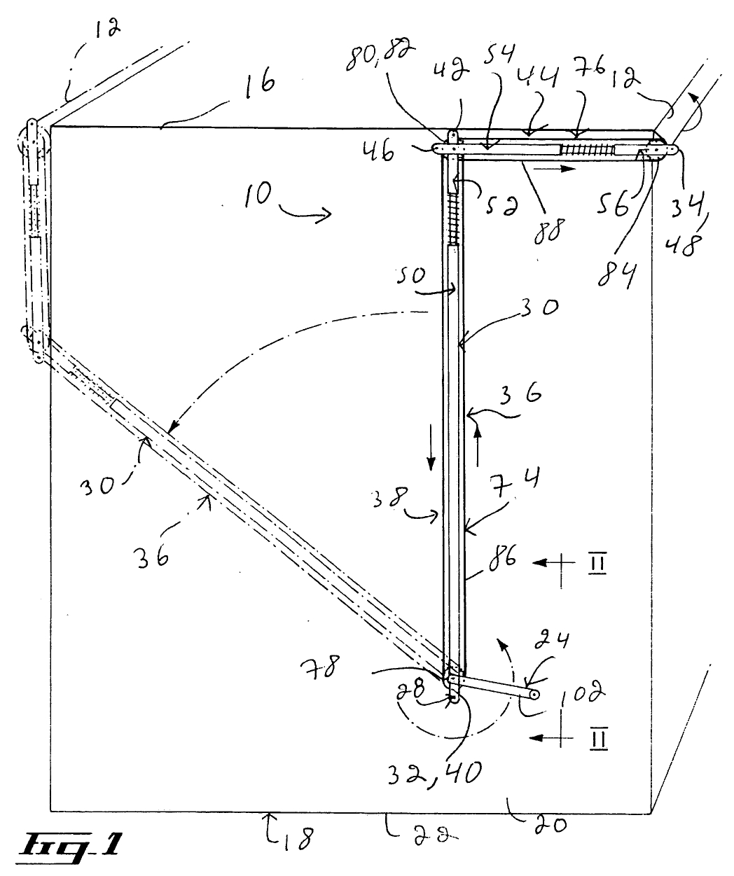

FIG. 1 illustrates a device 10 for manipulating a tarpaulin 12 in accordance with an embodiment of the present invention. The device 10 is provided to selectively cover and uncover a top aperture 16 of a container 18. The container 18 includes a peripheral wall 20 and a bottom wall 22, the top aperture 16 being defined by the peripheral wall 20 and located substantially opposed to the bottom wall 22. However, in alternative embodiments of the invention, the container 18 is any other suitable container.

The reader skilled in the art will readily appreciate that directional designations such as up, down, front, rear and side used in the present document are used only for clarity purposes and that the device 10 may be used with containers 18 having any suitable orientations.

The tarpaulin 12 is configurable between an extended configuration and a retracted configuration. In the extended configuration, the tarpaulin 12 substantially covers the top aperture 16. In FIG. 1, the tarpaulin 12 is shown in full lines in the extended configuration. In the retracted configuration, the tarpaulin 12 is substantially retracted from the top aperture 16. In FIG. 1, the tarpaulin 12 is shown in phantom lines in the retracted configuration.

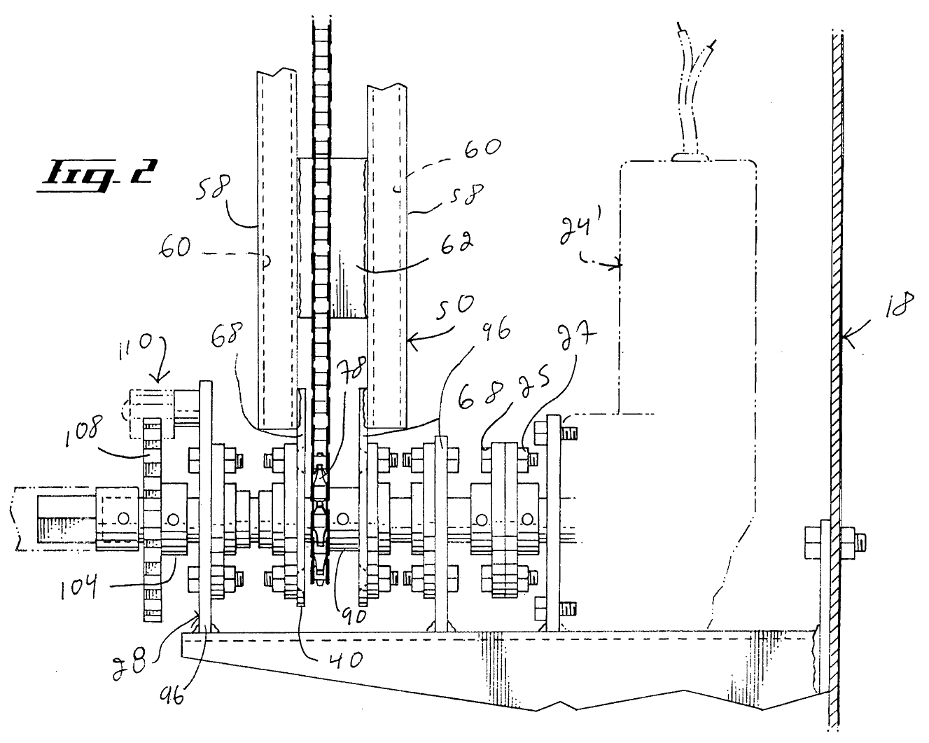

The device 10 is usable in combination with an actuator 24 providing a rotational motion. The actuator 24 is spaced apart from the top aperture 16. The actuator 24 is manually actuated and will be described in further details hereinbelow. In some embodiments of the invention, an alternative actuator 24′, shown in FIG. 2, includes an electric motor. In some embodiments of the invention, both actuators 24 and 24′ are usable alternatively to operate the device 10. In this latter embodiment, the electric motor powered actuator 24′ is removably attached to the device 10, for example through the use of nuts 25 and bolts 27 (seen in FIG. 2) coupling the actuator 24′ to the device 10. Removing the nuts 25 and bolts 27 decouple the actuator 24′ from the actuator 24 and therefore allows manual operation of the device 10.

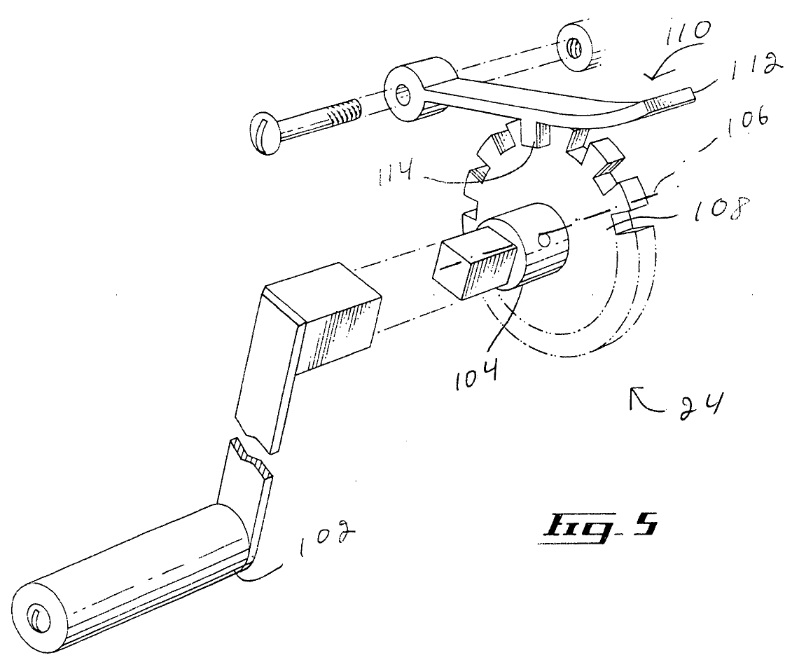

The device 10 includes a rod 14 (better seen in FIG. 4) for rolling the tarpaulin 12 therearound when configuring the tarpaulin 12 from the extended configuration to the retracted configuration and for unrolling the tarpaulin 12 therefrom when configuring the tarpaulin 12 from the retracted configuration to the extended configuration. The rod 14 defines a rod longitudinal axis 26.

Referring to FIG. 1, the device 10 also includes a mounting bracket 28 attachable to the container 18 in a spaced apart relationship relatively to the top aperture 16, and an articulated linking element 30. The articulated linking element 30 defines a linking element first end 32 and a substantially opposed linking element second end 34. The articulated linking element 30 is pivotally attached to the mounting bracket 28 substantially adjacent to the linking element first end 32. The articulated linking element 30 is rotatably attached to the rod 14 substantially adjacent to the linking element second end 34. The articulated linking element 30 is movable between a first configuration and a second configuration. The articulated linking element 30 is in the first configuration when the tarpaulin 12 is in the retracted configuration. The articulated linking element 30 is the second configuration when the tarpaulin 12 is in the extended configuration.

A transmission 36 is operatively coupled to the actuator 24 and to the rod 14 for rotating the rod 14 about the rod longitudinal axis 26 when the actuator 24 is actuated. Upon the actuator 24 being actuated, the rod 14 is rotated about the rod longitudinal axis 26 through the transmission 36 and moved across the top aperture 16, which, in turn, moves the articulated linking element 30 between the first and second configurations. Movements between the first and second configurations of the articulated linking element 30 allow the rod 14 to remain linked to the actuator 24 while remaining substantially adjacent to the top aperture 16 as the rod 14 is moved thereacross between the extended and retracted configurations.

The articulated linking element 30 includes a first arm 38 and a second arm 44. The first and second arms 38 and 44 are pivotable relatively to each other. In some embodiments of the invention, as shown in the drawings, the articulated linking element 30 includes only two arms 38 and 44. However, in alternative embodiments of the invention, the articulated linking element 30 includes more than two arms 38 and 44.

The first arm 38 is substantially elongated and defines a first arm first end 40 and a substantially longitudinally opposed first arm second end 42. Similarly, the second arm 44 is substantially elongated and defines a second arm first end 46 and a substantially longitudinally opposed second arm second end 48. The first and second arms 38 and 44 are pivotally attached to each other substantially adjacent to the first arm second end 42 and to the second arm first end 46. The first arm first end 40 substantially coincides with the linking element first end 32 and is therefore substantially adjacent to the mounting bracket 28. The second arm second end 48 substantially coincides with the linking element second end 34.

The first arm 38 includes a first arm first segment 50 and a first arm second segment 52. The first arm first and second segments 50 and 52 are substantially longitudinally movable relatively to each other to allow variations in a distance between the first arm first and second ends 40 and 42. Therefore, the first arm 38 is telescopic. Similarly, the second arm 44 includes a second arm first segment 54 and a second arm second segment 56. The second arm first and second segments 54 and 56 are substantially longitudinally movable relatively to each other to allow variations in a distance between the second arm first and second ends 46 and 48.

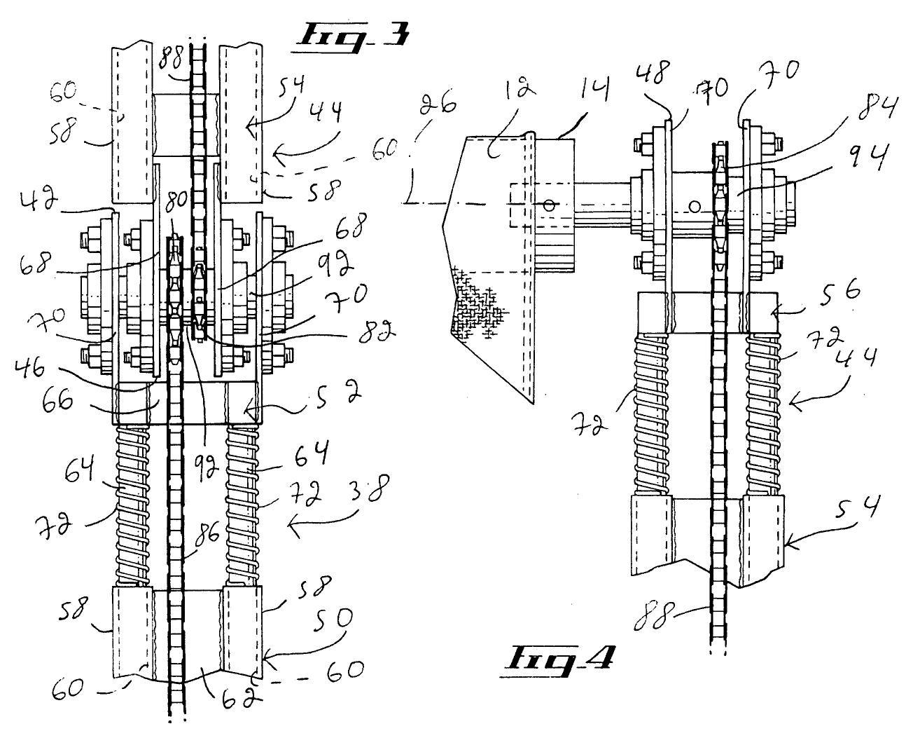

The first and second arms 38 and 44 have substantially similar structures. As seen for example in FIG. 3, the first arm first segment 50 includes a pair of substantially parallel rods 58 extending substantially spaced apart from each other. The rods 58 are hollow and each define a respective passageway 60 extending substantially longitudinal therethrough. Plates 62 extend between the rods 58 at various longitudinally spaced apart locations therealong. The first arm second segment 52 includes a pair of relatively shorter rods 64 having a outer diameter substantially similar to an inner diameter of the passageways 60. The rods 64 extend in a substantially parallel and spaced apart relationship relatively to each other and are attached to each other by a plate 66. The rods 64 are each inserted into a respective passageway 60 so as to be substantially longitudinally movable therealong.

As seen in FIG. 2, the first arm first segment 50 defines a pair of first end plate 68 extending in a substantially parallel and spaced apart relationship relatively to each other and extending substantially longitudinally away from the rods 58 substantially adjacent to the first arm first end 40. The first end plates 68 are usable for mounting the first arm first segment 50 to the mounting bracket 28. As seen in FIG. 3, the first arm second segment 52 defines a pair of second end plates 70 extending in a substantially parallel and spaced apart relationship relatively to each other and extending substantially longitudinally away from the rods 64 substantially adjacent to the first arm second end 42. The second end plates 70 are usable for attaching the first and second arms 38 and 44 to each other. The first and second end plates 68 and 70 are each substantially perpendicular to a plane extending across the rods 64.

The second arm first and second segments 54 and 56 are substantially similar respectively to the first arm first and second segments 50 and 52. The second arm first segment 54 defines a pair of first end plate 68 extending in a substantially parallel and spaced apart relationship relatively to each other and extending substantially longitudinally away from the rods 58 substantially adjacent to the second arm first end 46. The first end plates 68 are usable for mounting the second arm first segment 54 to the first arm second segment 52. The first end plates 68 of the second arm 44 are spaced apart by a smaller distance than the second end plates 70 of the first arm so as to be insertable therebetween. As seen in FIG. 4, the second arm second segment 56 defines a pair of second end plates 70 extending in a substantially parallel and spaced apart relationship relatively to each other and extending substantially longitudinally away from the rod 64 substantially adjacent to the second arm second end 48. The second end plates 70 are usable for attaching the second arm second segment 56 and the rod 14 to each other.

As seen for example in FIG. 3, a biasing element 72 is operatively coupled to the first arm first and second segments 50 and 52 for biasing the first arm first and second segment 50 and 52 substantially longitudinally away from each other. For example, the biasing element 72 includes a pair of coil spring each mounted onto a respective one of the rods 64 and abutting at one end thereof onto the rods 58 of the first arm first segment 50 and at the other end thereof against the plate 66 joining the rods 64 of the first arm second segment 52. Biasing elements 72 substantially similar to the above described biasing elements are also provided on the second arm 44.

As seen in FIG. 1, the transmission 36 includes a transmission first element 74 mounted to the first arm 38 and operatively coupled to the actuator 24 for being operated thereby. A transmission second element 76 is mounted to the second arm 44 and operatively coupled to the transmission first element 74 so as to be operated thereby. The transmission second element 76 is operatively coupled to the rod 14 so that the rod 14 is rotated about the rod longitudinal axis 26 when the transmission second element 76 is operated.

The transmission first element 74 includes a pair of first element sprockets 78 and 80 rotatively mounted to the first arm 38 in a substantially longitudinally spaced apart relationship relatively to each other. A first element chain 86 is mounted to the pair of first element sprockets 78 and 80 so as to be movable therearound. As seen on Fig.2, one of the first element sprockets 78 is mounted between the first end plate 68 through an axle 90 rotatable relatively to the first end plates 68. The other one of the first element sprockets 80 is mounted between the first end plate 68 of the second arm second segment 56 to an axle 92. The axle 92 pivotally couples the first and second arms 38 and 44 to each other, as well as allowing free rotation of the first element sprocket 80 relatively to both the first arm 38 and the second arm 44.

Referring to FIG. 1, the transmission second element 76 includes a pair of second element sprockets 82 and 84 rotatively mounted to the second arm 44 in a substantially spaced apart relationship relatively to each other. A second element chain 88 is mounted to the pair of second element sprockets 82 and 84 so as to be movable therearound. As seen in FIG. 3, one of the second element sprockets 84 is mounted between the second end plates 70 of the second arm 44 through an axle 94. The axle 94 is jointly rotatable with the rod 14 so that the second element sprocket 84 and the rod 14 are substantially jointly rotatable about the rod longitudinal axis 26. The other one of the second element sprockets 82 is mounted between the first end plates 68 of the second arm second segment 56 to the axle 92.

The first element sprockets 80 is a first element coupling sprocket 80 and the second element sprocket 82 is a second element coupling sprocket 82. The first and second element coupling sprocket 80 and 82 are mounted to the first and second arms 38 and 44 so as to the substantially jointly rotatable relatively to the first and second arms 38 and 44.

The first arm first and second segments 50 and 52 allow variations in an inter-sprocket distance between the first element sprockets 78 and 80. The second arm first and second segments 54 and 56 similarly allow variations in an inter-sprocket distance between the second element sprockets 82 and 84. These variations in distance allow for relatively easily mounting the first and second element chains 86 and 88 respectively to the first element sprockets 78 and 80 and to the second element sprockets 82 and 84. The biasing element 72 creates a tension in the first and second element chains 86 and 88 and therefore ensures proper operation of the device 10, as well as compensates for the wear these first and second element chains 86 and 88

As better seen in FIG. 5, the actuator 24 includes a handle 102. The handle 102 is operatively coupled to the transmission 36 for rotating the first element sprocket 78 upon the handle 102 being rotated. An advantage of having a manually-actuated device is that there is no need to link the container 18 and the device 10 to a power source to operate the device 10.

The actuator 24 includes an axle 104 defining an axle longitudinal axis 106. The axle 104 is mechanically coupled to the first element sprocket 78 for rotating the first element sprocket 78 upon the axle 104 being rotated about the axle longitudinal axis 106. To that effect, the axle 104 is mechanically coupled to the axle 90 so as to be substantially jointly rotatable therewith.

In some embodiments of the invention, as seen in FIG. 5, the actuator 24 includes a lock 110 for selectively allowing or preventing a rotation of the handle 102. In a specific embodiment of the invention, the lock 110 includes a lever 112 defining a tooth 114 for engaging a toothed gear 108 mounted to the axle 104 for joint rotation therewith about the axle longitudinal axis 106. The lever 112 is movable between a locked position in which the tooth 114 engages the toothed gear 108 and an unlocked position in which the tooth 114 is disengaged from the toothed gear 108.

As seen in FIG. 2, the mounting bracket 28 typically includes plates 96 extending in a substantially parallel and spaced apart relationship relatively to each other for allowing mounting of the axle 90 thereto.

In some embodiments of the invention, the first and second element sprockets 78, 80, 82 and 84 all have substantially similar diameters and substantially similar number of teeth. However, in some embodiments of the invention, these first and second element sprockets 78, 80, 82 and 84 have different number of teeth and diameters. In these embodiments, a ratio between a number of turns of the actuator 24 required to achieve a predetermined number of turns of the rod 14 about the rod longitudinal axis 26 is not equal to one, thereby providing a mechanical advantage to the operator of the device 10.

Although the present invention has been described as including sprockets and chains, it is within the scope of the present invention to have similar devices in which the sprockets are replaced by pulleys and chains are replaced by belts.

In some embodiments of the invention, the tarpaulin 12 is biased towards the opened or closed configuration by a device similar to the device described in U.S. patent application Ser. No. 11/603,021 filed on Nov. 22, 2006 by the inventor named in the present Patent Application, which is hereby incorporated by reference in its entirety. However, in alternative embodiments of the invention, the tarpaulin 12 is either not biased or is biased in any other suitable manner using an alternative device.

Although the present invention has been described hereinabove by way of preferred embodiments thereof, it can be modified, without departing from the spirit and nature of the subject invention as defined in the appended claims.

What is claimed is:

1. A device for manipulating a tarpaulin to selectively cover and uncover a top aperture of a container, said tarpaulin being configurable between an extended configuration and a retracted configuration, wherein, in said extended configuration, said tarpaulin substantially covers said top aperture, and, in said retracted configuration, said tarpaulin is substantially retracted from said top aperture, said device being usable in combination with an actuator, said device comprising:
a rod for rolling said tarpaulin therearound when configuring said tarpaulin from said extended configuration to said retracted configuration and for unrolling said tarpaulin therefrom when configuring said tarpaulin from said retracted configuration to said extended configuration, said rod defining a rod longitudinal axis;
a mounting bracket attachable to said container in a spaced apart relationship relatively to said top aperture;
an articulated linking element, said articulated linking element defining a linking element first end and a substantially opposed linking element second end, said articulated linking element being pivotally attached to said mounting bracket substantially adjacent to said linking element first end, and said articulated linking element being rotatably attached to said rod substantially adjacent to said linking element second end, said articulated linking element being movable between a first configuration and a second configuration, said articulated linking element being in said first configuration when said tarpaulin is in said retracted configuration, and said articulated linking element being in said second configuration when said tarpaulin is in said extended configuration; and
a transmission operatively coupled to said actuator and to said rod for rotating said rod about said rod longitudinal axis when said actuator is actuated;
whereby, upon said actuator being actuated, said rod is rotated about said rod longitudinal axis through said transmission and moved across said top aperture, which, in turn, moves said articulated linking element between said first and second configurations, movements between said first and second configurations of said articulated linking element allowing said rod to remain linked to said actuator while remaining substantially adjacent to said top aperture as said rod is moved thereacross between said extended and retracted configurations.

2. A device as defined in claim 1, wherein said articulated linking element includes a first arm and second arm, said said first and second arms being pivotable relatively to each other.

3. A device as defined in claim 2, wherein said first arm is pivotally attached to said mounting bracket and said rod is rotatably attached to said second arm.

4. A device as defined in claim 3, wherein said transmission includes
a transmission first element mounted to said first arm and operatively coupled to said actuator for being operated thereby; and
a transmission second element mounted to said second arm and operatively coupled to said transmission first element so as to be operated thereby, said transmission second element being operatively coupled to said rod so as to rotate said rod about said rod longitudinal axis when said transmission second element is operated.

5. A device as defined in claim 4, wherein
said first arm is substantially elongated and defines a first arm first end and substantially longitudinally opposed first arm second end; and
said second arm is substantially elongated and defines a second arm first end and a substantially longitudinally opposed second arm second end;
said first and second arms being pivotally attached to each other substantially adjacent to said first arm second end and substantially adjacent to said second arm first end.

6. A device as defined in claim 5, wherein said transmission first element includes a pair of first element sprockets rotatably mounted to said first arm in a substantially longitudinally spaced apart relationship relatively to each other and a first element chain mounted to said pair of first element sprockets so as to be movable therearound.

7. A device as defined in claim 6, wherein said transmission second element includes a pair of second element sprockets rotatably mounted to said second arm in a substantially longitudinally spaced apart relationship relatively to each other and a second element chain mounted to said pair of second element sprockets so as to be movable therearound, said pairs of first and second element sprockets including respectively a first element coupling sprocket and a second element coupling sprocket, said first and second element coupling sprockets being mounted respectively to said first and said second arms so as to be substantially jointly rotatable relatively to said first and second arms.

8. A device as defined in claim 6, wherein said first arm includes a first arm first segment and a first arm second segment, each of said first element sprockets being mounted to a respective one of said first arm first and second segments, said first arm first and second segment being substantially longitudinally movable relatively to each other to allow variations in an inter-sprocket distance between said first element sprockets.

9. A device as defined in claim 8, further comprising a biasing element operatively coupled to said first arm first and second segments for biasing said first arm first and second segments substantially longitudinally away from each other to create a tension in said first element chain.

10. A device as defined in claim 1, further comprising a lock for selectively preventing said actuator from being actuated.

11. A device as defined in claim 1, wherein said transmission provides a non-unitary ratio between a number of rod rotations of said rod about said rod longitudinal axis and a number of actuator rotations of said actuator causing said number of rod rotations.

12. A device for manipulating a tarpaulin to selectively cover and uncover a top aperture of a container, said tarpaulin being configurable between an extended configuration and a retracted configuration, wherein, in said extended configuration, said tarpaulin substantially covers said top aperture, and, in said retracted configuration, said tarpaulin is substantially retracted from said top aperture, said device comprising:
a rod for rolling said tarpaulin therearound when configuring said tarpaulin from said extended configuration to said retracted configuration and for unrolling said tarpaulin therefrom when configuring said tarpaulin from said retracted configuration to said extended configuration, said rod defining a rod longitudinal axis;
a mounting bracket attachable to said container in a spaced apart relationship relatively to said top aperture;
an articulated linking element, said articulated linking element defining a linking element first end and a substantially opposed linking element second end, said articulated linking element being pivotally attached to said mounting bracket substantially adjacent to said linking element first end, and said articulated linking element being rotatably attached to said rod substantially adjacent to said linking element second end, said articulated linking element being movable between a first configuration and a second configuration, said articulated linking element being in said first configuration when said tarpaulin is in said retracted configuration, and said articulated linking element being in said second configuration when said tarpaulin is in said extended configuration;
an actuator mounted to said mounting bracket; and
a transmission operatively coupled to said actuator and to said rod for rotating said rod about said rod longitudinal axis when said actuator is actuated;
whereby, upon said actuator being actuated, said rod is rotated about said rod longitudinal axis through said transmission and moved across said top aperture, which, in turn, moves said articulated linking element between said first and second configurations, movements between said first and second configurations of said articulated linking element allowing said rod to remain linked to said actuator while remaining substantially adjacent to said top aperture as said rod is moved thereacross between said extended and retracted configurations.
